(19) United States
(12) Patent Application Publication
(10) Pub. No.: US 2011/0293208 A1
(43) Pub. Date: Dec. 1, 2011

(54) PACKAGING

(75) Inventors: Parbinder Cheema, Middlesex (GB); Jason Denis Willey, Barry (GB)

(73) Assignee: Cadbury Holding Limited, Uxbridge Middlesex (GB)

(21) Appl. No.: 13/122,196

(22) PCT Filed: Oct. 7, 2009
(86) PCT No.: PCT/GB2009/002416

§ 371 Date: Aug. 15, 2011

(30) Foreign Application Priority Data
Oct. 7, 2008 (GB) 0818268.5

(51) Int. Cl. B31B 1/00; B65D 33/00

(52) U.S. Cl. 383/205; 493/267; 493/186

(57) ABSTRACT

Packaging particularly for display on a Euro-hook or the like comprises a bag or pouch (10) closed at one end by means of a header (14). A line of weakness (18) extends across the header dividing it into an outer portion (14A) and an inner portion (14B) both of which are sealed. An aperture (16) is provided in the outer portion (14B) of the header for suspending the packaging for display purposes. The outer portion (14A) can be separated from the inner portion after removal from the display hook by tearing along the line of weakness. The seal in the inner portion (14B) of the header is peelable to allow for ease of opening. A method of manufacturing the package and an apparatus (30) for forming the packaging are also disclosed. The apparatus includes a pair of cross jaws (32) having a punch for forming the aperture and at least one knife guide.

### TECHNICAL FIELD OF THE INVENTION

The present invention relates to packaging and in particular to the type of packaging comprising a bag or pouch and which is closed at one end by means of a seal to form a header. The invention also relates to a method and apparatus for producing such packaging.

### BACKGROUND TO THE INVENTION

It is known to provide packaging of the type in which a bag or pouch for containing one or more items is formed from a flexible material sealed at one end by means of a, usually transverse, seal to define a header. Often, an aperture is formed in the header so that the package can be suspended from a hook or the like for display purposes. Many products are packaged in this way, including confectionery items such as sweets, candies, chocolates and the like.

A problem with the known type of packaging is that it can be difficult to open due to the presence of the aperture in the header. Regions of increased strength and weakness are created in the header about the aperture so that attempts to open the package by peeling the header seal apart often results in the package tearing unpredictably. This can lead to spillage of the contents. Alternatively, an end user has to tear the material in order to remove all or part of the header portion or to otherwise gain access to the interior of a main body of the package in which the contents are held. The header can be difficult to tear and often attempts to open the package in this way result in a tear line which passes through the aperture and so does not allow access to the contents. In some cases, a user may tear a corner of the package, removing part of the header and part of the main body. Again this can lead to spillage of the contents.

Often the end user will wish to remove only some of the contents on first opening and to retain the remaining contents in the package. A problem with the known package is that it is not re-closable so that once opened it is not able to securely retain the remaining contents. This problem is exacerbated by the difficulties in opening discussed above which often result in the main body of the package being torn or otherwise damaged.

Where the contents of the package are degradable, such as foodstuffs including confectionery, the package can be constructed so that it is hermetically sealed in order to protect the contents from the environment. This helps to keep the contents fresh and suitable for consumption for a longer period time. A further problem with the known packaging is that once it has been opened, the package is no longer sealed and the remaining contents are exposed to the environment increasing the rate of degradation. This is a particular problem if the items retained in the package are not individually wrapped.

There is a need then for an improved package which overcomes, or at least mitigates, some or all of the problems of the known packaging.

There is also a need for an improved method and apparatus for manufacturing a package which overcomes, or at least mitigates, some or all of the problems of the known packaging

### SUMMARY OF THE INVENTION

In accordance with a first aspect of the invention, there is provided packaging comprising a bag or pouch closed at one end by means of a seal to form a header region, in which: a line of weakness extends across the header region dividing it into an outer portion and an inner portion both of which are sealed, the outer portion being separable from the inner portion by tearing along the line of weakness; an aperture is provided in the outer portion of the header by means of which the packaging can be suspended for display purposes; the seal in at least the inner portion of the header being peelable.

The seal in at least the inner portion of header may be re-sealable.

In one embodiment, the inner portion of the header is sealed by means of a peelable adhesive. The adhesive may be re-sealable adhesive and may be a heat sensitive adhesive or cold seal adhesive.

In an alternative embodiment, the inner portion of the header is sealed by means of a peelable weld.

In a still further embodiment, the seal in the inner portion of the header is provided by means of a mechanical sealing means such as a zip lock, finger press sealing strip, grip seal or the like.

The seal in the outer header portion may be formed by means of an adhesive which may be a peelable or a non-peelable adhesive. Where a peelable adhesive is used, the same peelable adhesive may be used to form the seal in both the inner and outer header portions. Alternatively, the seal in the outer header portion can be a welded seal.

The line of weakness may be provided by a line of perforations.

The aperture may be a Euro-slot configured to enable the package to be suspended from a Euro-hook.

A re-sealing tab may be provided for securing the inner header portion in a folded over condition after opening. The tab may have an adhesive on at least one face by means of which the tab is secured to the header portion, or another part of the package, to secure the inner header portion in a folded over position.

The bag or pouch may have a main body portion containing at least one item, the at least one item being sealed in the main body portion by means of the header region.

The main body portion may contain a plurality of items, which may be confectionery items.

In accordance with a second aspect of the invention, there is provided a method of manufacturing a packaging comprising a bag or pouch, the method comprising:
a. forming a sealed header region at one end of the bag or pouch;
b. producing a line of weakness extending across the header region dividing it into an outer header portion and an inner header portion, both portions being sealed;
c. producing an aperture in the outer portion of the header by means of which the packaging can be suspended for display purposes.

The method may comprise:
a. providing a set of cross-seal jaws, the jaws having a punch for producing the aperture;
b. clamping the jaws together on either side of the film to produce the header region and the aperture;
c. using a knife to produce the line of weakness.

The jaws may define a knife guide inboard of the punch, and the method may comprise introducing the knife through the knife guide whilst the jaws are clamped.

The method may be adapted for producing the bag or pouch from a continuous film, in which case, the method may comprise using a further knife to cut the film at an outer edge of the header region to separate the package from the remainder of the film. In this case, the jaws may define a further knife guide outboard of the punch, and the method may comprise introducing the further knife through the further knife guide.

The jaws may be heated to produce a welded seal at least in the outer header region. The jaws may be heated to produce a welded seal in the inner header portion.

The method may comprise forming the seal in the inner header portion using a cold seal adhesive. The method may also comprise using the same cold seal adhesive to form the seals in both the inner and the outer header portions.

The bag or pouch may be produced on a vertical form fill seal machine.

The bag or pouch may have a main body portion defining an internal volume for receiving at least one item to be packaged, the main body portion being closed by the header region and the method may comprise introducing at least one item into the main body portion prior to forming the header region so that the at least one item is retained in the main body portion once the sealed header region has been produced.

In accordance with a third embodiment of the invention, there is provided a set of cross-seal jaws for forming a bag or pouch, the jaws having opposing surfaces between which opposing portions of the bag or pouch can be clamped to produce a sealed header region, a punch for forming an aperture in the sealed header portion, and a knife guide spaced inboard of the punch through which a knife can be introduced to form a line of weakness extending across the sealed header region so as to divide the header region into inner and outer sealed portions.

The jaws may be adapted for use in producing a bag or pouch from a continuous film, in which case the jaws may have a further knife guide positioned outboard of the punch through which a further knife can be introduced to separate the bag or pouch from the remaining film.

The punch may comprise a cutting formation projecting from the opposing surface of one of the jaws for contact with the opposing surface of the other of the jaws when the jaws are clamped about the film.

The, or each, knife guide may comprise a through slot in one of jaws though which a knife can be introduced to cut the film whilst the film is clamped between the opposing surfaces of the jaws. The, or each, knife guide may further comprise a groove or slot in the opposing surface of the other of the jaws, the groove or slot aligning with the through slot when the jaws are clamped about the film.

In accordance with a fourth aspect of the invention, there is provided a vertical form fill apparatus for forming and filling a package in accordance with the first aspect of the invention or for carrying out the method in accordance with the second aspect of the invention, the apparatus comprising a set of cross-seal jaws in accordance with the third aspect of the invention when adapted for use in producing a bag or pouch from a continuous film.

The apparatus may further comprise a first knife and a mechanism for introducing the first knife through the inboard knife guide means and a second knife and a mechanism for introducing the second knife through the outboard knife guide.

The apparatus may include a heating arrangement for heating at least part of the opposing surfaces of the jaws which form the outer header portion.

The heating arrangement may heat the whole of the opposing surfaces of the jaws.

### DETAILED DESCRIPTION OF THE INVENTION

An embodiment of the invention will now be described, by way of example only, with reference to the accompanying drawings, in which:

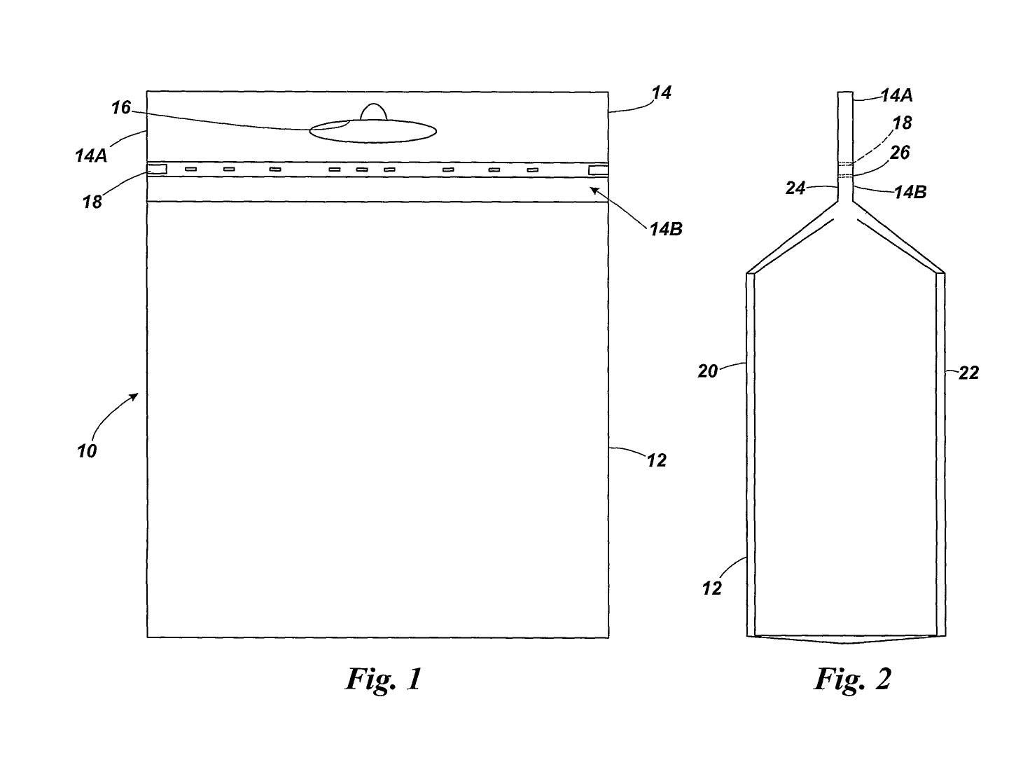

FIG. 1 is a front elevation of a package in accordance with the invention;

FIG. 2 is a side elevation of the package of FIG. 1;

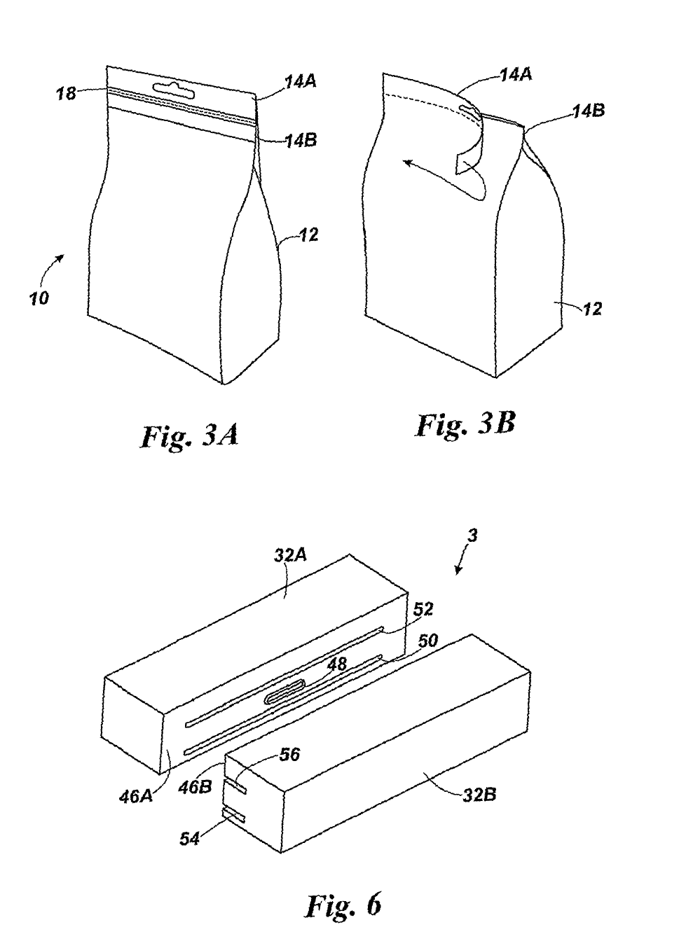

FIGS. 3A and 3B are perspective views of the package of FIG. 1, illustrating how an outer portion of a header region of the package can be removed to open the package;

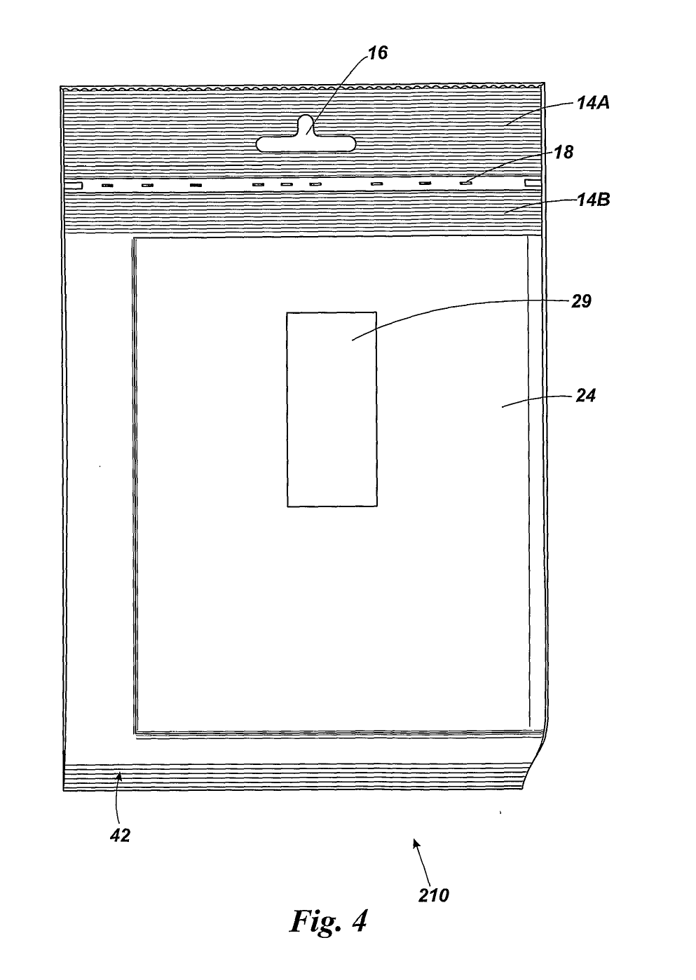

FIG. 4 is a front elevation view of an alternative embodiment of a package in accordance with the invention having a re-sealing tab;

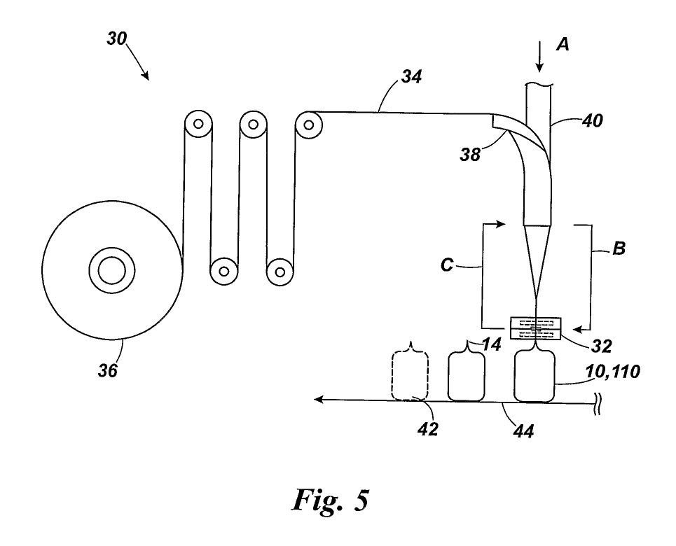

FIG. 5 is a schematic representation of a vertical form fill apparatus which may be used to produce packaging in accordance with the invention;

FIG. 6 is a perspective view of a pair of jaws that can be used to form a header region of a package in accordance with the invention;

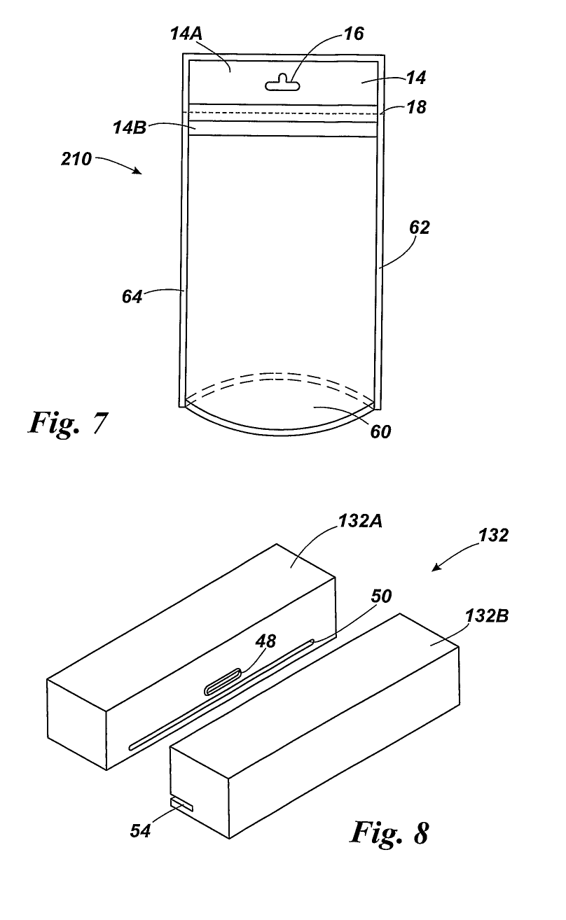

FIG. 7 is a front elevation view of a further alternative embodiment of a package in accordance with the invention; and,

FIG. 8 is a perspective view of a modified pair of jaws that can be used to form a header region in the pancake of FIG. 7.

With reference initially to FIGS. 1 to 3B, a package 10 in accordance with the invention comprises a bag or pouch which is formed from a flexible material. The package has a main body region 12 defining an internal volume for receiving and containing one or more items and is closed at one end by means of a transverse seal to form a header region 14. An aperture 16 is provided in the header region 14 to enable the package to be suspended for display purposes. In one embodiment, the aperture 16 is in the form of a so called Euro-slot to enable the package to be suspended from a Euro-hook but this is not essential. The area around the aperture can be reinforced or strengthened. For example, the front and rear parts of the header may be fused together or additionally sealed in the area around the aperture.

As so far described, the package 10 is conventional and provides a fully sealed, pre-filled bag or pouch suitable for a variety of products, including but not limited to confectionery products such as sweets, candies, chocolates, gum and the like. The material used to form the package can be any suitable flexible material including plastics, foil or laminates. Depending on the nature of the contents, the package 10 can be constructed so as to be hermetically sealed in order to protect the contents from the environment.

In accordance with the invention, a line of weakness 18 extends across the header 14 to divide it into an outer portion 14A and an inner portion 14B. The outer portion 14A of the header contains the aperture 16 and is separable from the inner portion 14B by tearing along the line of weakness 18, as illustrated in FIG. 3B. Both the inner and outer header portions 14A, 14B are sealed, so that the package remains sealed by virtue of the inner header portion 14B when the outer header portion 14A is initially removed. In the present embodiment, the line of weakness 18 is provided by means a line of perforations extending across the width of the header 14 but other methods for forming the line of weakness can be used, such as laser etching for example.

In use, the package 10 is hung up for display using the aperture 16. Once an end user or consumer has removed the package 10 from its display, the outer header portion 14A with the hanging slot 16 is removed by tearing along the line of weakness 16. At this stage the package remains sealed by virtue of the inner header portion 14B which can be peeled apart in a predictable manner to open the package. For example, the consumer could open the inner header seal 14B by grasping opposing main sides 20, 22 of the package and pulling them apart to peel the opposing sides 24, 26 of the inner header portion 14B apart. Alternatively, the outer edges of the inner header portion 14B adjacent the line of weakness 18 may not be sealed. With this arrangement, once the outer header portion 14A has been removed a user can grasp the edges of the inner header portions 24, 26 and pull them apart to open the package.

The header seal 14 can be formed in a number of ways. In one embodiment, the material is heated so that the opposing portions of material 24, 26 that form the header are fused together to form a welded seal. Both the outer header portion 14A and the inner header portion 14B may have welded seals. Alternatively, at least the seal in the inner header portion 14B can be formed using a peelable adhesive. The peelable adhesive can be of any suitable type and may be heat and/or pressure sensitive. In one embodiment, the inner header portion 14B is sealed using a peelable and re-sealable adhesive. This is advantageous as it enables the inner header portion 14B to be re-closed after the package has been opened. The outer header portion 14A may also be sealed using an adhesive if desired.

Where adhesive is used to seal the outer header portion 14A, the adhesive may be a permanent adhesive or a peelable adhesive. In one embodiment, the same peelable adhesive is used to seal both the inner 14B and outer 14A header regions. This significantly simplifies the manufacturing process and hence reduces manufacturing costs. A peelable adhesive can be used in the outer header region 14A because it is usually larger than the inner header region 14B and so has a larger amount of adhesive applied to it. This forms a tight bond and makes it difficult to pull the outer header region apart. In contrast, a relatively small strip of peelable adhesive will usually be used to seal the inner header region 14B which is relatively easier to peel apart. Furthermore, since the outer header region 14A takes all the strain when the package is hung on a Euro-slot arm or other hook, the peelable seal formed in the lower header region 14B is left intact. It may be particularly advantageous if the same peelable adhesive is used to form all the seals in the package including any base or side seals and both the inner and outer header seals.

References to a re-sealable adhesive should be understood as encompassing adhesives that can be used to re-close the packaging by holding the opposed sides of the inner header portion together so as to safely retain the contents without necessarily forming a perfect or hermetic seal.

In a further alternative embodiment (not shown) inner header portion 14B may be sealed without using an adhesive or welding but by means of an alternative sealing means. For example, a zip lock, finger press sealing strip, grip seal or other similar mechanical sealing means can be used to form the seal in the inner header portion.

Where the inner header portion 14B is sealed by means of a re-sealable adhesive or an alternative re-sealable sealing means, the package 10 can be re-closed by pressing opposing sides 24, 26 of the inner header portion 14B together. This enables the remaining contents to be safely retained within the re-closed package.

FIG. 4 illustrates an alternative embodiment of a package 110 in accordance with the invention which has a re-sealing tab 29 attached to one of the main sides 24 of the package. Once the package has been opened, at least the inner header portion 14B can be folded over and secured in position using the tab 29. This helps to keep the remaining contents secure and is particularly useful where the inner header does not have a re-closable seal. A part of the tab 29 may be permanently secured to the side of package with a further part being secured by means of a peelable and resealable adhesive. In this arrangement, the further part of the tab 29 can be released from the side of the package and fastened to the inner header portion, or to another part of the package, to secure the inner header portion in a folded over condition. Alternative, the whole of the tab 29 may be secured to the side of the package using a peelable and re-sealable adhesive, or other similar means. In this case the whole of the tab 29 can be removed from the side of the package and repositioned to hold the inner header portion in a folded over condition. The tab 29 may be in the form of a strip of sticky tape.

Packages 10, 110 in accordance with the invention can be produced using any suitable method. However, in one embodiment, they are produced using a continuous vertical form fill apparatus 30 illustrated schematically in FIG. 5 and the header 14 is produced using a set of cross-seal jaws, such as the jaws 32 illustrated in detail in FIG. 6.

The vertical form fill apparatus 30 draws a film of packaging material 34 from a reel 36 and passes it over a forming shoulder 38 to form the film into a cylinder. The cylindrical film is passed over a filling tube 40 through which the products to be packaged are introduced into each package in turn as indicated by arrow A in FIG. 5. Whilst the film is passing over the cylinder, overlapping longitudinal edges of the film are sealed together to produce a cylindrical tube of film.

The jaws 32 are clamped about the cylindrical film at the base of the filling tube to produce a header region 14 to seal the upper end of one package 10, 110 after it has been filled and to produce a seal 42 at the base of the next package. Whilst still in a clamped condition, the jaws are moved downwardly, as indicated by arrow B in FIG. 5, drawing the film with them so that the next partially formed package is maneuvered into a filling position. During this process a knife or other cutting device is used to separate the filled package from the base seal of next package. The jaws are then separated and moved upwardly, as indicated by arrow C in FIG. 5, to clamp the film at the base of the filling tube once the next package has been filled and the process is repeated. The jaws 32 are shown schematically at the lower position in FIG. 5 in which the base of the filled container is located just above a moving conveyor belt 44 on to which the package drops when the jaws 32 are opened.

The jaws 32 may be heated to produce welded header and base seals or if a heat sensitive adhesive is used. However, where the whole of the header seal is produced using a cold seal adhesive applied to the film, the jaws may just apply a pressure to form the header seal.

The jaws 32 have opposing surfaces 46A, 46B which are brought together to clamp opposing portions of the film in between when forming the header and base seals. One of the jaws 32A has a cutting formation or punch 48 projecting from its opposing surface 46A and which passes through the film to contact the opposing surface 46B of the other jaw when the jaws are clamped about the film. The punch 48 is shaped and positioned to produce the hanging aperture 16 in the outer header portion 14A.

As so far described, the apparatus and jaws 32 are largely conventional. However, in order to produce a package in accordance with the invention, the jaws 32 have a knife guide 50 spaced inboard of (below) the punch 48. The knife guide 50 is used to guide a knife (not shown) which produces the line of perforations 18 dividing the header 14 into inner 14B and outer 14A header portions. In the present embodiment in which the package is formed from a continuous film, the jaws have a further knife guide 52 spaced outboard of (above) the punch 48 which is used to guide a further knife (not shown) for separating the filled and sealed package 10, 110 from the remaining film in a conventional manner.

The first knife guide 50 comprises a slot which passes through one of the jaws 32A at a position between the punch 33 and a lower edge of the jaw. The second knife guide 52 is also in the form of a through slot in the jaw 32A but is located at a position between the punch 33 and an upper edge of the jaw 32A. Whilst the jaws are clamped together, a first knife or other cutting device (not shown) is inserted through the inner guide 50 to form the line of perforations 18 and a second knife is inserted through the second, outer guide 52 to cut the film separating the package 10 from the remainder of film in a conventional manner The other jaw 32B has a pair of grooves 54, 56 which align with the slots 50, 52 when the jaws are clamped, so that a part or parts of the knives can be received in the grooves when cutting or perforating the film.

The region of the jaws 52 between the two knife guides produces the seal in the outer header portion 14A, whilst the region of the jaws below the inner knife guide 50 produces the seal in the inner header portion 14B. The base seal 42 is produced by the region of the jaws above the outer knife guide 52.

The term “knife” is used herein (including the claims) to mean any suitable cutting device for cutting the film or producing the line of perforations 18 as appropriate and should be construed accordingly. The term “knife guide” should also be construed as covering a guide for any suitable cutting means.

As discussed above, the jaws 32 may be heated where the seals are formed using a heat sensitive adhesive or where the opposing portions of the film are fused together to form a welded seal. In one embodiment the whole of the opposing surfaces 46A, 46B is heated so that both the inner and outer header portions 14A, 14B have welded seals.

In an alternative embodiment, the seal in the inner header portion 14B is produced using a cold seal pressure sensitive adhesive which is peelable and which may also be resealable. In this case, a lower part of the jaws which form the inner header portion may not be heated. However, the upper regions of the jaws may be heated so that the outer header portion and the base are sealed by means of welding or using a heat sensitive adhesive. Where the whole of the header is to be formed using a cold seal pressure adhesive, the jaws need not be heated at all.

The use of a pair of jaws 32 as described above in a continuous vertical form fill machine provides a convenient method of producing a package in accordance with the invention but it should be understood that packaging in accordance with the invention can be produced by may suitable method.

Cross-seal jaws 32 similar to those described above can be used to produce a wide variety of packages in accordance with the invention and are not limited to use in forming so called “quad” bags having four side panels as illustrated in FIGS. 1 to 4 or for use with a vertical from fill apparatus.

FIG. 7 illustrates an alternative packaging 210 in accordance with the invention having an inserted base 60 and which is not produced using a vertical form fill apparatus. The package 210 is produced by forming a sheet of material into a cylinder and sealing the loose ends of the sheet together along one edge 62. The opposing side 64 of the sheet is then folded and sealed so that the cylinder is given an oval cross section. A separate section of material is sealed fused in position at a lower end of the sheet to form the base 60. This produces a pouch open at a top end through which the pouch can be filled, typically by means of a hopper (not shown) located above a conveyor belt on which the bag is travelling. Once the bag has been filled, the top is sealed to produce a header region 14. In accordance with the invention, the header 14 can be divided into outer and inner header portions 14A, 14B by means of a line of perforations 18 and a slot 16 formed in the outer header portion 14A to enable the package 210 to be hung for display purposes. The header 14 in this embodiment can be constructed in accordance with any of the arrangements described above in relation to the previous embodiments 10, 110.

Although the package 210 is not produced using a form fill apparatus, the header region 14 can still be advantageously produced using a set of cross-seal jaws similar to the jaws 32 described above. FIG. 8 illustrates a modified set of cross-seal jaws 132 for use in producing the packaging 210. The modified jaws 132 are essentially the same as the jaws 32 as described above, to which the reader should refer for details. However, since it is not necessary to separate the package 210 from a web or film of material after the header has been produced, the outer knife guide 52 is omitted and the modified jaws 132 are only provided with an inner knife guide 50. The inner knife guide is positioned between the punch 48 and a lower edge of the jaw 132A for use in guiding a knife for forming the line of perforations 18 which divides the header into inner and outer header regions.

Use of the modified jaws 132 is advantageous as the header 14, the slot 16, and the line of perforations 18 separating the inner and outer header regions 14A, 14B can be produced at a single processing stage.

Packages 10, 110, 210 in accordance with the invention can be used to package a wide variety products including, but not limited to, confectionery products such as sweets, candies, chocolates, gum and the like. It should be understood that the invention in all its embodiments is not limited to application with the types of package shown in the accompanying drawings but can be applied to any suitable packaging comprising a bag or pouch with header region and which is intended for display by hanging from a Euro-hook or the like.

1. Packaging comprising a bag or pouch closed at one end by means of a seal to form a header region, in which: a line of weakness extends across the header region dividing it into an outer portion and an inner portion both of which are sealed, the outer portion being separable from the inner portion by tearing along the line of weakness; an aperture is provided in the outer portion of the header by means of which the packaging can be suspended for display purposes;
the seal in at least the inner portion of the header being peelable.

2. Packaging as claimed in claim 1, in which the seal in at least the inner portion of header is re-closable.

3. Packaging as claimed in claim 1, in which at least the inner portion of the header is sealed by means of a peelable adhesive.

4. Packaging as claimed in claim 1, in which at least the inner portion of the header is sealed by means of a re-sealable adhesive.

5. Packaging as claimed in claim 1, in which the inner portion of the header is sealed by a heat sensitive adhesive.

6. Packaging as claimed in claim 1, in which the inner portion of the header is sealed by a cold seal adhesive.

7. Packaging as claimed in claim 1, in which at least the inner portion of the header is sealed by means of a peelable weld.

8. Packaging as claimed in claim 1, in which the seal in the inner portion of the header is provided by means of a mechanical sealing means such as a zip lock, finger press sealing strip, grip seal or the like.

9. Packaging as claimed in claim 3, in which the seal in the outer header portion is formed by means of an adhesive.

10. Packaging as claimed in claim 9, in which the adhesive used to faun the seal in the outer header portion is non-peelable.

11. Packaging as claimed in claim 9, in which the same peelable adhesive is used to form the seal in both the inner and the outer header portion.

12. Packaging as claimed in claim 1, in which the seal in the outer header portion is formed by means of a weld.

13. Packaging as claimed in claim 1, in which the line of weakness is provided by a line of perforations.

14. Packaging as claimed in claim 1, in which the aperture is a slot configured to enable the package to be suspended from a Euro-hook.

15. Packaging as claimed in claim 1, in which a re-sealing tab is provided for securing the inner header portion in a folded over condition.

16. Packaging as claimed in claim 15, in which the tab has an adhesive on at least one face by means of which the tab can be secured to the header portion, or another part of the package, to secure the inner header portion in a folded over position.

17. Packaging as claimed in claim 1, the bag or pouch comprising a main body portion containing at least one item, the at least one item being sealed in the main body portion by means of the header region.

18. Packaging as claimed in claim 17, in which the main body portion contains a plurality of items, which may be confectionery items.

19. (canceled)

20. A method of manufacturing a packaging comprising a bag or pouch, the method comprising:
a. forming a sealed header region at one end of the bag or pouch;
b. producing a line of weakness extending across the header region dividing it into an outer header portion and an inner header portion, both portions being sealed;
c. producing an aperture in the outer portion of the header by means of which the packaging can be suspended for display purposes.

21. A method as claimed in claim 20, the method comprising:
a. providing a set of cross-seal jaws, the jaws having a punch for producing the aperture;
b. clamping the jaws together on either side of opposing regions of the bag or pouch to produce the header region and the aperture;
c. using a knife to produce the line of weakness.

22. A method as claimed in claim 21, in which the jaws define a first knife guide inboard of the punch, the method comprising introducing the knife through the knife guide.

23. A method as claimed in claim 22, in which the method is adapted for producing the bag or pouch from a continuous film, the method comprising using a further knife to cut the film at an outer edge of the header region to separate the package from the continuous film.

24. A method as claimed in claim 23, in which the jaws define a further knife guide outboard of the punch, the method comprising introducing the further knife through the further knife guide.

25. A method as claimed in claim 21, in which the jaws are heated to produce a welded seal at least in the outer header region.

26. A method as claimed in claim 25, in which the jaws are heated to produce a welded seal in the inner header portion.

27. A method as claimed in claim 20, the method comprising forming the seal in the inner header portion using a cold seal adhesive.

28. A method as claimed in claim 27, the method comprising forming the seals in the inner and outer header portions using the same cold seal adhesive.

29. A method as claimed in claim 20, in which the bag or pouch is produced on a vertical form fill seal machine.

30. A method as claimed in claim 20, in which the bag or pouch comprises a main body portion defining an internal volume for receiving at least one item to be packaged, the main body portion being closed by the header region; the method comprising introducing at least one item into the main body portion prior to forming the header region.

31. (canceled)

32. A set of cross-seal jaws for forming a bag or pouch, the jaws having opposing surfaces between which opposing portions of the bag or pouch can be clamped to produce a sealed header region, a punch for forming an aperture in the sealed header portion, and a knife guide spaced inboard of the punch through which a knife can be introduced to form a line of weakness extending across the sealed header region so as to divide the header region into inner and outer sealed portions.

33. A set of cross-seal jaws as claimed in claim 32, in which the jaws are adapted for use in producing a bag or pouch from a continuous film, the jaws have a further knife guide positioned outboard of the punch through which a further knife can be introduced to separate the bag or pouch from the remaining film.

34. A set of cross-seal jaws as claimed in claim 32, in which the punch comprises a cutting formation projecting from the opposing surface of one of the jaws for contact with the opposing surface of the other of the jaws when the jaws are clamped about the film.

35. A set of cross-seal jaws as claimed in claim 32, in which the, or each, knife guide comprises a through slot in one of jaws though which a respective knife can be introduced to cut the film whilst the film is clamped between the opposing surfaces of the jaws.

36. A set of cross-seal jaws as claimed in claim 35, in which the, or each, knife guide comprises a groove or slot in the opposing surface of the other of the jaws, the groove or slot aligning with the through slot when the jaws are clamped about the film.

37-41. (canceled)

42. A set of cross-seal jaws as claimed in claim 32 wherein at least a part of the opposing surfaces of said jaws are heated.

43. A set of cross-seal jaws as claimed in claim 42 wherein the whole of the opening surface of said jaws are heated.
